(19) United States
(12) Patent Application Publication
(10) Pub. No.: US 2006/0156784 A1
(43) Pub. Date: Jul. 20, 2006

(54) Crimping apparatus

(76) Inventors: Michael L. Reedy, Beaumont, TX (US); Linda A. Reedy, Beaumont, TX (US)

Correspondence Address: SCOTT D. COMPTON, 2386 South Dairy Ashford Rd. #593, Houston, TX, 77077, US

(21) Appl. No.: 11/035,549

(22) Filed: Jan. 15, 2005

(51) Int. Cl. B25B 7/12

(52) U.S. Cl. 72/412

(57) ABSTRACT

A crimping apparatus for applying crimps about crimping targets in jewelry making and the like. The crimping apparatus folds multiple crimps of various shapes, sizes and materials.

### FIELD OF THE APPLICATION

The application relates generally to a crimping tool used in jewelry making and the like.

### BACKGROUND

In jewelry making, crimping is a technique used to attach a crimp to the end of a ribbon, cord or leather strip. It consists of placing the ribbon, cord or leather strip within a crimp and folding the sides of the crimp inward to grip the ribbon, cord or strip. Current crimp folding techniques make use of handheld pliers such as electrical pliers, crimping pliers, needlenose and roundnose pliers. These pliers employ double levers that move about a fixed fulcrum and close together at a decreasing angle.

### SUMMARY

An apparatus for applying a crimp about a crimping target comprising a tooth crimping element, a bore crimping element spaced apart from the tooth crimping element and configured to bear a crimp and crimping target placed adjacent the crimp, and a frame securing the tooth crimping element. The tooth crimping element is movable relative to the frame along a linear path wherein the bore crimping element is positioned in the linear path such that the tooth crimping element is movable along the linear path to engage the bore crimping element and to fold the crimp about the crimping target.

### BRIEF DESCRIPTION OF THE FIGURES

FIG. 1 illustrates a side view of a crimping apparatus.

FIG. 2 illustrates a top view of a first support and a second support.

FIG. 3 illustrates a detail view of the tooth crimping element.

FIG. 4a illustrates a view of the bore crimping element and the tooth crimping element each comprising a removable die.

FIG. 4b illustrates a view of the bore crimping element and the tooth crimping element minus the removable dies.

FIG. 4c illustrates a view of removable dies standing apart from the bore crimping element and the tooth crimping element.

FIG. 5a illustrates a view of a tooth bore and crimping tooth in an unmated position.

FIG. 5b illustrates a view of a crimp in both unfolded and folded position.

FIG. 6 illustrates a side view of at least a second embodiment of the present invention.

### BRIEF DESCRIPTION

The present application relates to a crimping apparatus that allows for uniform and simultaneous folding of crimps of various shapes, sizes and materials onto crimping targets.

Preferably, the crimping apparatus of the present invention includes a tooth crimping element, a bore crimping element, a first support, a second support, and a lever arm or other handle. The lever arm or other handle may be operated to move the tooth crimping element along a predetermined path to engage the bore crimping element, wherein a crimp is secured. The crimping apparatus according to the present application will be described in more detail with reference to the embodiments illustrated in the drawings. The drawings are illustrative only, and are not to be construed as limiting the invention, which is defined in the claims.

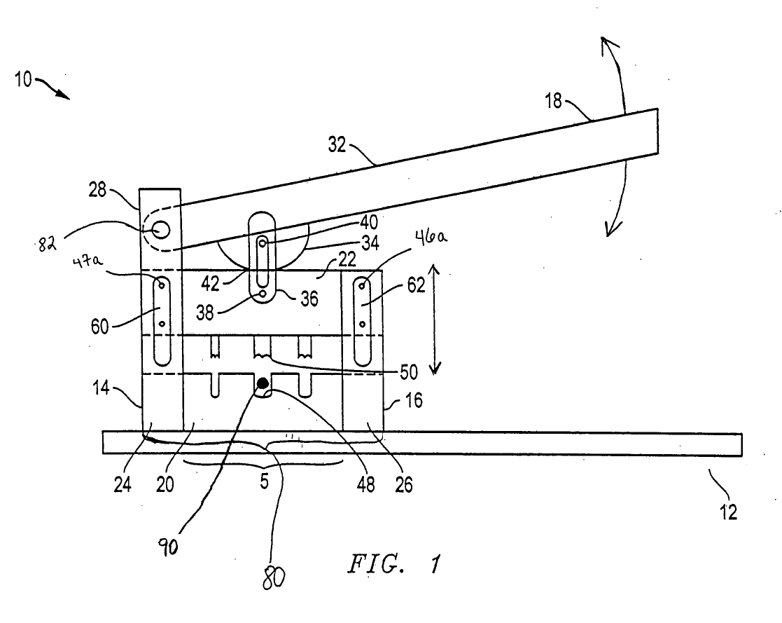

In a preferred embodiment, as shown in FIG. 1, a crimping apparatus 10 includes a base 12, a first support 14, a second support 16, a lever arm 18, a bore crimping element 20, and a tooth crimping element 22. The base 12 supports the working parts of crimping apparatus 10, while first support 14 and second support 16 operate as a frame to secure both bore crimping element 20 and tooth crimping element 22. As is further explained below, the frame 80 retains the tooth crimping element 22 therewith. More specifically, the frame 80 and tooth crimping element 22 are attachably engaged, whereby the tooth crimping element 22 is movable relative to the fixed frame 80 along a linear path. The frame restricts movement of the crimping element along this linear path. Referring to FIG. 1, the linear path of tooth crimping element is defined by the alignment of at least one of slots 60 or 62 and the restriction of travel of at least pins 46a and 47a therein.

Base 12 supports the crimping apparatus 10 on a platform or other level area. A platform includes but is not necessarily limited to a table, floor, wall and any other level area on which to place the crimping apparatus 10 during operation. In a preferred embodiment, base 12 is attached to bore crimping element 20. Suitably, at least the bore crimping element 20 is securely attached to base 12. Bore crimping element 20 may be attached by any suitable means such as a screw, suitably a machine screw. The bore crimping element 20 is spaced apart from tooth crimping element 22 and is positioned in or adjacent to the linear path of the tooth crimping element 22. In operation, at least one crimp and at least one crimping target 90 are placed adjacent in the bore crimping element. When tooth crimping element 22 is moved along the linear path toward base 12, the tooth crimping element 22 engages the bore crimping element 20 holding the crimp securely therein. The crimp is thereby applied to or folded about the crimping target 90. Preferred crimping targets 90 include but are not necessarily limited to ribbon, cord and leather strips used in jewelry making and the like.

In at least a first embodiment, first support 14 and second support 16 each have a first piece or slot and a second piece or slot. The two pieces of first support 14 attach to a rear end 24 of bore crimping element 20 and the two pieces of second support 16 attach to a front end 26 of bore crimping element 20. The bore crimping element 20 is sandwiched between the two pieces of supports 14 and 16.

In at least a second embodiment, bore crimping element 20 is attached to a single first support 14 and second support 16 at rear end 24 and front end 26. Preferably, bore crimping element 20 is attached to the side of first support 14 and second support 16 by any suitable means such as a rivet or screw, suitably a machine screw.

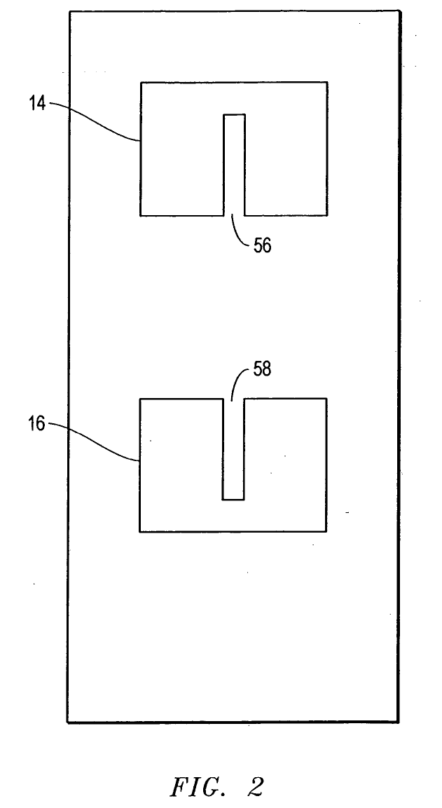

In at least a third embodiment, as shown in FIG. 2, first support 14 and second support 16 are equipped with rails or grooves 56, 58 extending about the vertical height of supports 14 and 16. Grooves 56, 58 have a width sized to accommodate the thickness of the bore crimping element 20. Specifically, the bore crimping element 20 lies nearly flush with grooves 56, 58 thereby securing the bore crimping element 20 to first support 14 and second support 16 without further attachment. Depending on the application requirements, first support 14 and second support 16 may be further secured to bore crimping element 20 by any suitable means such as a screw, suitably a machine screw or set screw.

In yet another embodiment, bore crimping element 20 lies securely between first support 14 and second support 16 without further attachment. Preferably, each of bore crimping element 20, first support 14, and second support 16 has a rectangular shape with flat sides resulting in a flush alignment between bore crimping element 20 and both supports 14 and 16. Bore crimping element 20 may be further attached to the first support 14 and second support 16 by any suitable means such as a screw, suitably a machine screw or set screw.

Preferably, the width of bore crimping element 20, and each of first and second supports 14, 16 are up to about the width of base 12. The width of each element is governed by the particular crimping application and the support strength necessary for a given application. In any of the above embodiments, first support 14 and second support 16 may be securely attached to both bore crimping element 20 and to base 12. In a particular embodiment, each of these three elements or parts may be removable from base 12, and the crimping apparatus 10 may be fully disassembled down to each of its individual parts. Disassembly allows the crimping apparatus 10 to be easily repaired with replacement parts as needed. In the alternative, bore crimping element 20 and/or first and second supports 14, 16 may be permanently attached to the base 10 and first and second supports 14, 16 may each be permanently attached to bore crimping element 20. Likewise, supports 14 and 16 and bore crimping element 20 may also comprise one-piece solid construction.

As shown in FIG. 1, lever arm 18 is positioned adjacent to tooth crimping element 22 and is pivotably attached to an end 28 of first support 14. Suitably, lever arm 18 is attached to first support 14 using a pin, prong or other hinge type element. The lever arm 18 may be pivoted about pin 82 across a predetermined range of angular motion. As will be further described below, angular movement of lever arm 18 translates directly to movement of tooth crimping element 22 along a linear path. Any other type of handle or knob may be used to move tooth crimping element 22. However, a lever mechanism is preferred to generate the force applied to tooth crimping element 22 by utilizing a reduced manual force being applied to lever arm 18 during crimping.

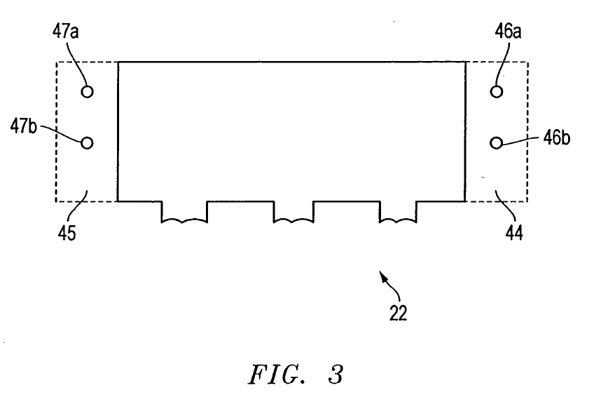

Tooth crimping element 22 is preferably aligned in relation to both first support 14 and second support 16 in like manner as bore crimping element 20. Thus, tooth crimping element 22 may engage supports 14 and 16 by (a) sandwiching the tooth crimping element 22 between the individual pieces of supports 14 and 16; (b) attaching tooth crimping element 22 to the side of supports 14 and 16; or (c) fitting tooth crimping element 22 within grooves 56, 58. As shown in FIGS. 1 and 3, tooth crimping element 22 has extensions 44 and 45 that extend out from opposing ends of tooth crimping element 22 beyond spacing 5 to the edges of supports 14 and 16. Each of extensions 44 and 45 include at least pins 46a and 47a that are aligned with and travel inside slots 60 and 62. The linearly shaped slots 60 and 62 restrict and guide the movement of tooth crimping element 22 along a predetermined linear path.

Lever arm 18 and tooth crimping element 22 are attached together by at least one link or spring 36. Preferably, a link 36 is attached to tooth crimping element 22 by at least one pivoting pin 38, and to lever arm 18 by at least one arm pin 40. Pivoting pin 38 extends out from tooth crimping element 22 to engage link 36. Arm pin 40 extends out from lever arm 18 to engage at least one link slot 42 of link 36. In addition, the width of link slot 42 is sufficient to engage arm pin 40, while link slot 42 has a length up to about the length of link 36. Suitably, link 36 is about ¾″ to about 1 ½″ in length, and link slot 42 is about ⅞″ to about 1 ⅜″ in length. The thickness of link 36 is suitable for engaging pivoting pin 38 and arm pin 40. Suitably, the thickness of link 36 is at least about 1/16″ to about ¼″. Link 36 may be made of any material suitable for continuous crimping operations. Suitable materials include but are not necessarily limited to wood, aluminum, steel, and plastic.

In at least a first embodiment, at least one arm pin 40 and at least one link 36 are positioned on either side of lever arm 18. In at least a second embodiment, at least two arm pins 40 and at least two links 36 are positioned, one on either side, of lever arm 18.

A suitable lever arm 18 has a neck 32 and cam 34. Link 36 allows lever arm 18 to move with tooth crimping element 22 as force is applied to tooth crimping element 22 through cam 34. Preferably, cam 34 includes at least a semicircle design having a radius that extends from the cam side of lever arm 18 to the outer edge of cam 34. In operation, as lever arm 18 moves towards base 12, cam 34 engages tooth crimping element 22 about a normal interface thereby transferring or applying a force upon tooth crimping element 22. As a result, tooth crimping element 22 is moved toward bore crimping element 20. The length of slots 60 and 62 allows tooth crimping element 22 to move linearly from a point of greatest distance apart from bore crimping element 20, to a point of engagement with bore crimping element 20.

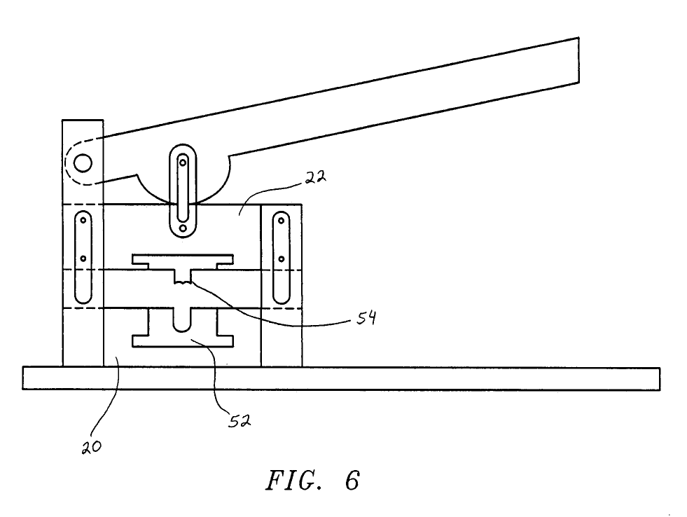

Bore crimping element 20 is further defined by at least one tooth bore 48. A preferred tooth bore 48 includes an open channel that runs the width of bore crimping element 20. Tooth crimping element 22 is further defined by at least one crimping tooth 50. A preferred crimping tooth 50 includes a width corresponding to about the width of tooth crimping element 22. In operation, a plurality of both tooth bores 48 and crimping teeth 50 may be incorporated into the crimping apparatus 10. As shown in FIG. 1, the crimping apparatus includes a total of three tooth bores 48 and a total of three crimping teeth 50. The crimping apparatus of FIG. 6 includes a single tooth bore 48 and a single crimping tooth 50.

Suitably, the size, shape and total number of tooth bores 48 equals the size, shape and total number of crimping teeth 50. Also, the size, shape and total number of tooth bores 48 and crimping teeth 50 are determined by the desired crimping operation. In a preferred embodiment, the width of tooth bore 48 is greater than the width of crimping tooth 50 so that tooth bore 48 and crimping tooth 50 come together in a mating position as tooth crimping element 22 contacts a crimp stored within bore crimping element 20. Tooth bore 48 and crimping tooth 50 are preferably made from any material strong enough to fold a preferred crimp when the crimp is engaged by crimping tooth 50. Tooth crimping element 22 may be of a one piece construction that provides an integrally formed crimping tooth 50. Or, crimping tooth 50 may be detachable from tooth crimping element 22. Preferably, tooth crimping element 22 and crimping tooth 50 are at least made from the same material or materials including similar properties as to hardness and durability.

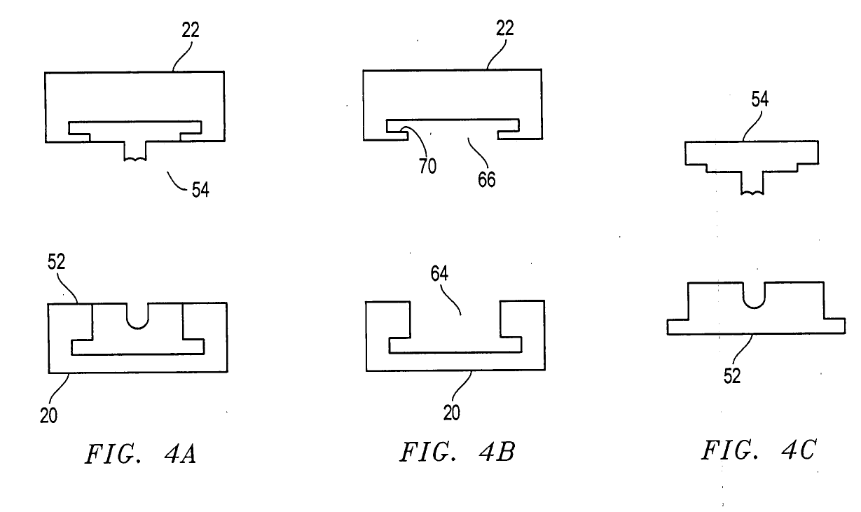

In an alternative embodiment, as shown in FIGS. 4 a-c, bore crimping element 20 may further include a removable bore die 52 and tooth crimping element 22 may further include a removable tooth die 54. Removable bore die 52 may include any number, size and shape of tooth bores 48. Likewise, removable tooth die 54 may include any number, size and shape of crimping teeth 50. Suitably, the size, shape and number of tooth bores 48 of removable bore die 52 corresponds to the size, shape and number of crimping teeth 50 of removable tooth die 54. Dies 52 and 54 allow for various sizes, shapes and numbers of crimps to be used without having to replace the bore and tooth crimping elements 20 and 22 during operation.

In operation, removable dies 52 and 54 fit within recesses 64 and 66 of the bore crimping element 20 and tooth crimping element 22, respectively. As seen in FIG. 4b, recess 66 includes at least one winged end 70 to secure removable die 54 within recess 66. In addition, each of removable dies 52, 54 and each of recesses 64 and 66 may include a width up to about the width of crimping elements 20, 22, wherein removable dies 52 and 54 may be slid into and out of either side of recesses 64 and 66 to a secured position. The size and shape of recesses 64 and 66 further accommodates the size and shape of removable dies 52 and 54 so that removable dies 52 and 54 are secured within recesses 64 and 66 during crimping. In the alternative, any type of latch or other locking mechanism may be employed to eliminate any potential lateral movement of removable dies 52 and 54 within recesses 64 and 66.

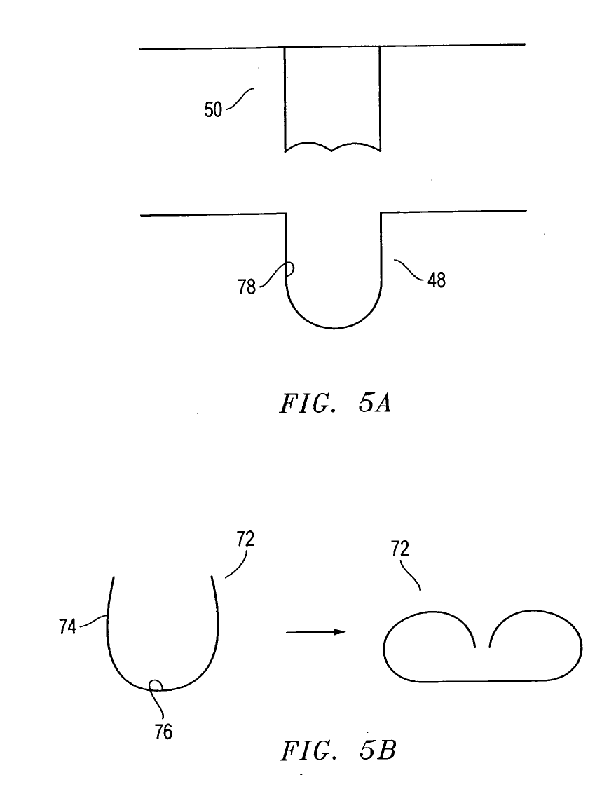

As shown in FIGS. 5a and 5b, the dimensions and design of both the tooth bore 48 and crimping tooth 50 are determined by the size and shape of the crimp to be folded. A preferred crimp 72 is U-shape in design and includes sidewalls 74 and bottom 76. As further shown in FIGS. 5a and 5b, tooth bore 48 correlates in size and shape to crimp 72, thereby securely storing the crimp 72 during folding of the crimp 72.

The furthest part of crimp tooth 50 preferably includes two equal concave sections that meet at the center of the furthest part of crimp tooth 50. As shown in FIG. 5b, the preferred design of the furthest part of crimp tooth 50 allows the edges of crimp 72 to curve inward until both edges of sidewalls 74 meet in the middle of the bottom 76 of crimp 72 in a folded position. Preferably, any tooth bore 48 and crimp tooth 50 design that allows the edges of sidewalls 74 to curve inward to meet in the middle of the bottom 76 of crimp 72 in a folded position may be employed. In addition, since each set of matching tooth bores 48 and crimping teeth 50 correlate in size and shape, multiple crimps 72 of various shapes and sizes can be folded simultaneously, regardless of the size crimp 72 used.

The size of each of the working parts of crimping apparatus 10 may be determined by factors including but not necessarily limited to the desired crimping application, the size of the crimps to be used and the material from which a desired crimp is made. Suitably, crimps in jewelry making are to be applied to crimping targets including but not necessarily limited to ribbon, cord, leather strips or any other material used in jewelry making. In addition, the crimping apparatus 10 may be designed to operate on any commercially available crimp of various sizes and materials. Likewise, the crimping apparatus may be designed to operate on any other crimp requiring folding of the sidewalls of the crimp as discussed above.

The crimping apparatus 10 may further be designed to operate on crimps of any given size. In practice, a commercially available crimp includes a bottom having a width of at least about 2 mm. Preferred commercially available crimps have widths from about 6 mm to about 11 mm. Commercially available crimps are typically made from materials including but not necessarily limited to gold, silver, platinum, stainless steel, aluminum, copper and any other material suitable for crimping in jewelry making. Commercially available crimps may be obtained from Crafts etc., in Oklahoma City, Okla.

### EXAMPLE 1

A crimping apparatus is provided that comprises a base 12, a first support 14, a second support 16, a lever arm 18, a bore crimping element 20, and an tooth crimping element 22 and link 36 having the following dimensions:

| | WIDTH | HEIGHT | LENGTH |
|---|---|---|---|
| Base | 1.5″ | 0.25″ | 8.0″ |
| First Support | 0.25″ | 3.0″ | 0.5″ |
| Second Support | 0.25″ | 2.0″ | 0.5″ |
| Lever arm | 0.5″ | 0.5″ | 7.0″ |
| Bore Crimping | 0.5″ | 0.75″ | 3.0″ |
| Element | | | |
| Tooth Crimping | 0.5″ | 0.75″ | 3.0″ |
| Element | | | |
| Link* | 0.5″ | | 1.25″ |

*The link further comprises a 1/8″ thickness and a link slot 7/8″ in length.

In addition, pins 46a and 47a extend out 0.25″ and fit within slots 60, 62 corresponding in length to the link slot 42. Cam 34 comprises a radius of 0.5″ and an arm pin 40 that extends out 0.25″.

Using the above described crimping apparatus 10, a 6 mm crimp is placed within a tooth bore 48 approximately (¼″ deep×¼″ wide), as described above. A ribbon, common to jewelry making and arts and crafts is placed lengthwise within tooth bore 48 and rests upon crimp 72 at a preferred crimping position along the ribbon. Once the ribbon is placed in proper position, lever arm 18 is motioned towards base 12 until tooth crimping element 22 engages bore crimping element 20. As tooth crimping element 22 engages bore crimping element 20, crimp tooth 50 forces the sidewalls 74 of crimp 72 inward where the edges of the sidewalls 74 contact the ribbon in a secure manner. Lever arm 18 is motioned away from base 12 to a furthest position thereby separating tooth crimping element 22 from bore crimping element 20.

Persons of ordinary skill in the art will recognize that many modifications may be made to the present application without departing from the spirit and scope of the application. The embodiment described herein is meant to be illustrative only and should not be taken as limiting the application, which is defined in the claims.

We claim:

1. An apparatus for applying a crimp about a crimping target comprising:
a tooth crimping element;
a bore crimping element spaced apart from said tooth crimping element and configured to bear a crimp and crimping target placed adjacent the crimp; and
a frame securing said tooth crimping element, said tooth crimping element being movable relative to said frame along a linear path;
wherein said bore crimping element is positioned in said linear path such that said tooth crimping element is movable along said linear path to engage said bore crimping element and to fold the crimp about the crimping target.

2. The crimping apparatus of claim 1, further comprising a base for supporting said crimping apparatus on a platform.

3. The crimping apparatus of claim 1, further comprising a lever arm positioned adjacent said tooth crimping element and movable to move said tooth crimping element along said linear path.

4. The crimping apparatus of claim 3, wherein said lever arm further includes a cam engageable with said tooth crimping element to apply a force thereto in the direction of said linear path.

5. The crimping apparatus of claim 3, wherein said lever arm is pivotable about said frame.

6. The crimping apparatus of claim 5, further comprising a link attaching said lever arm to said tooth crimping element.

7. The crimping apparatus of claim 1, wherein said frame has a slot and said tooth crimping element has a pin positioned in said slot such that said slot restricts the movement of the tooth crimping element along said linear path.

8. The crimping apparatus of claim 1, wherein said bore crimping element includes at least one tooth bore bearing the crimp and crimping target placed adjacent the crimp, and wherein said tooth crimping element includes at least one crimping tooth aligned with said tooth bore such that said crimping tooth engages the crimp when said tooth crimping element engages the bore crimping element.

9. The crimping apparatus of claim 1, wherein said bore crimping element includes a removable bore die having at least one tooth bore for bearing the crimp and crimping target placed adjacent the crimp, and wherein said tooth crimping element includes a removable tooth die having at least one crimping tooth for folding said crimp.

10. A crimping apparatus bearing a crimp and crimping target comprising:
a tooth crimping element having a plurality of crimping teeth for folding crimps;
a bore crimping element spaced apart from said tooth crimping element, said bore crimping element having a plurality of tooth bores aligned with said crimping teeth and configured to bear a plurality of crimps and crimping targets; and
a frame securing said tooth crimping element, said tooth crimping element being movable toward said bore crimping element to engage said bore crimping element such that said crimping teeth engage said crimps in said tooth bores wherein the crimps are folded about the crimping targets.

11. The crimping apparatus of claim 10, further comprising a lever arm positioned adjacent said tooth crimping element and movable to move said tooth crimping element along said path.

12. The crimping apparatus of claim 11, wherein said lever arm is pivotable about said frame.

13. The crimping apparatus of claim 10, wherein said frame has a slot, and said tooth crimping element has a pin positioned in said slot such that said slot restricts the movement of the tooth crimping element along said path.

14. The crimping apparatus of claim 10, wherein said tooth crimping element includes at least one removable tooth die, and wherein said bore crimping element includes at least one removable bore die.

15. A system for folding a crimp, said system comprising:
a crimping apparatus including,
a tooth crimping element;
a bore crimping element, and
a frame securing said tooth crimping element, said tooth crimping element being movable toward said bore crimping element to engage said bore crimping element; and
a tooth die that is securable to and removable from said tooth crimping element.

16. The system of claim 15, further comprising a bore die that is securable to and removable from said bore crimping element.

17. The system of claim 16, wherein said removable bore die includes at least one tooth bore bearing the crimp and crimping target placed adjacent the crimp, and wherein said removable tooth die includes at least one crimping tooth aligned with said tooth bore such that said crimping tooth engages the crimp when said tooth crimping element engages the bore crimping element.

18. The system of claim 16, further comprising a lever arm positioned adjacent said tooth crimping element and movable to move said tooth crimping element along said path.

19. The sytem of claim 17, wherein said lever arm is pivotable about said frame.

20. The system of claim 16, wherein said frame has a slot, and said tooth crimping element has a pin positioned in said slot such that said slot restricts the movement of the tooth crimping element along said path.
